(19) United States
(12) Patent Application Publication
(10) Pub. No.: US 2008/0030456 A1
(43) Pub. Date: Feb. 7, 2008

(54) Apparatus and Methods for Providing Motion Responsive Output Modifications in an Electronic Device

(75) Inventor: Mehrzad Asadi, San Jose, CA (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/458,410

(22) Filed: Jul. 19, 2006

(51) Int. Cl. G09G 5/00

(52) U.S. Cl. 345/156

(57) ABSTRACT

A portable electronic device includes multiple user output records and a user interface configured to generate a user detectable output corresponding to a selected one of the multiple user output records. The device also includes a motion detector configured to generate motion information that is indicative of movement of the portable electronic device and a controller configured to randomly select one of the multiple user output records to be generated by the user interface as the user detectable output responsive to the motion information.

### BACKGROUND

The present invention relates to the field of electronic devices in general and, more particularly, to apparatus and methods for providing output modifications in an electronic device.

Electronic devices, such as wireless communication terminals (e.g. cellular telephones), are widely used to store and output digital multimedia files and the like. Digital multimedia files can include digital audio, digital video, and digital image files, among others. Electronic devices can include speakers and/or speaker or headphone jacks for providing audio output to a user. Some electronic devices include video displays capable of displaying digital image files and digital video files.

The digital multimedia files maybe delivered to a user based on a predetermined sequence, for example, as a slideshow. A user can also manually select a sequence of files. For example, audio files may be played in an order determined by a playlist that is generated by the device or by the user. Without a deliberate change to the playlist using, for example, a device control menu or other input mechanism, the user will generally hear the audio files in the same order every time.

Similarly, image files used, for example, in a display background, may be displayed in a predetermined order and changed at predetermined intervals. The order and/or interval may become predictable and uninteresting to many users. However, many users lack the time, desire, or knowledge to manually change the order or sequence of display of images.

### SUMMARY

Embodiments of the present invention provide apparatus and methods for modifying a device output responsive to device motion. Some embodiments can be implemented as a portable electronic device that includes a plurality of user output records and a user interface configured to generate a user detectable output corresponding to a selected one of the plurality of user output records. The device also includes a motion detector configured to generate motion information that is indicative of movement of the electronic device and a controller configured to randomly select one of the plurality of user output records to be generated by the user interface as the user detectable output responsive to the motion information.

In further embodiments, the motion detector is configured to detect a specified type of movement and the controller is configured to select one of the plurality of user output records when the motion information indicates the specified type of movement. The specified type of movement may be user definable and the controller may be configured to define the specified type of movement based on the motion information when a program mode of the controller is selected. The specified type of movement may be a plurality of specified types of movement and the controller may be configured to select a different one of the user output records responsive to respective ones of the plurality of specified types of movement.

In other embodiments, the electronic device includes a random number generation module that is configured to generate a random number responsive to the motion information and the controller is configured to randomly select one of the user output records based on the random number. A plurality of user output records may be provided as an ordered list and the controller may be configured to sequentially select user output records from the ordered list for output by the user interface and to change the order in which the user output records are selected responsive to the motion information The user interface may be a display device and the user output records may include multiple visual properties that correspond to a visual theme, a background image and/or a video file. The visual properties include font, color and/or style.

In yet further embodiments, the device includes a disable switch configured to generate a disable signal. The controller is configured to maintain a selection of a previously selected one of the user output records responsive to a first state of the disable signal and to randomly select one of the user output records to be generated by the user interface as the user detectable output responsive to the motion information responsive to a second state of the disable signal.

In further embodiments, the controller is configured to separately select the user output records for different user interfaces and the disable switch is a multi-function switch that is configured to select disable of ones of the user interfaces. The first state of the disable signal includes multiple states, ones of which correspond to different ones of the different user interfaces. The controller is configured to maintain a corresponding previously selected one of the user output records for the user interface selected by the multi-function switch.

In other embodiments, the device includes a memory, wherein the user output records are stored in the memory. The device may include means for generating a random number responsive to the motion information.

In yet other embodiments, methods of modifying an output of an electronic device are provided. Multiple user output records are provided and movement of the electronic device is detected. One of the multiple user output records to be generated by a user interface is randomly selected as the user detectable output responsive to the motion information. A specified type of movement may be detected and one of the multiple user records may be selected responsive to the specified type of movement. The specified type of movement may be a user defined movement. Selecting may be preceded by generating, responsive to the motion information, a random number and selecting may include selecting based on the random number.

In yet further embodiments, the multiple user output records may be in an ordered list and selecting includes sequentially selecting user output records from the ordered list for output and changing the order in which the user output records are selected responsive to the motion information. Selecting may be followed by displaying the selected user output record and the selected user output record may include multiple visual properties that correspond to a visual theme, a background image and/or a video file. Selecting may be followed by playing the selected user output record, and the selected user output record may include an audio file and/or a music playlist.

In other embodiments, selecting is preceded by detecting a disable signal and selecting includes maintaining a selection of a previously selected one of the multiple user output records responsive to a first state of the disable signal and randomly selecting one of the multiple user output records to be generated by the user interface as the user detectable output responsive to the motion information responsive to a second state of the disable signal.

In yet other embodiments, portable electronic devices include a memory and a plurality of user output records stored in the memory. The device also includes a user interface configured to generate a user detectable output corresponding to a selected one of the plurality of user output records and a motion detector configured to generate motion information that is indicative of movement of the electronic device. The device further includes a disable switch configured to generate a disable signal and a controller configured to maintain a selection of previously selected one of the plurality of user output records responsive to a first state of the disable signal and to randomly select one of the plurality of user output records to be generated by the user interface as the user detectable output responsive to the motion information and a second state of the disable signal.

In yet other embodiments, at least one of the plurality of user output records is an image file. At least one of the plurality of user output records may be a music playlist and the controller may be configured to sequentially select songs from the music playlist to be played by the user interface and to change the order in which the songs are selected responsive to the motion information and the second state of the disable signal.

### BRIEF DESCRIPTION OF THE DRAWINGS

FIG. 1 is a block diagram illustrating an electronic device in accordance with some embodiments of the present invention.

FIG. 2 is a block diagram illustrating an electronic device having a display in accordance with some embodiments of the present invention.

FIG. 3 is a block diagram illustrating an electronic device having an audio output in accordance with some embodiments of the present invention.

FIG. 4 is a block diagram illustrating an electronic device having an audio output and a display in accordance with some embodiments of the present invention.

FIG. 5 is a block diagram illustrating a method of selecting a user detectable output of a portable electronic device according to some embodiments of the present invention.

FIG. 6 is a flow diagram illustrating a disabling function in accordance with some embodiments of the present invention.

FIG. 7 is a table illustrating exemplary functions of a multi-function disable switch in accordance with some embodiments of the present invention.

FIG. 8 is a block diagram illustrating an electronic device in accordance with further embodiments of the present invention.

### DETAILED DESCRIPTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

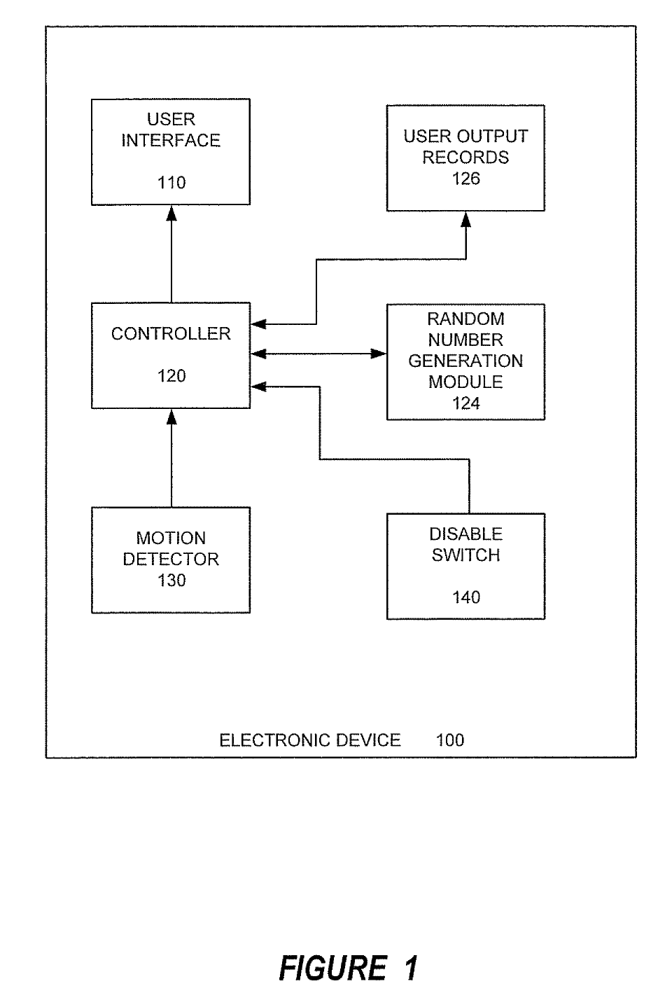

A portable electronic device according to some embodiments of the present invention will now be described with reference to the block diagram of FIG. 1. As shown in the embodiments of FIG. 1, a portable electronic device 100 may include user output records 126 that can be stored in, for example, memory within the device. Non-limiting examples of the user output records 126 include an audio file, a music playlist, multiple visual properties that correspond to a visual theme, a background image, and/or a video file, among others. The electronic device 100 includes a user interface 110 that is configured to provide a user detectable output. In some embodiments, the user interface 110 can be configured to display user output records 126 in the form of digital images and/or video content. The user interface 110 can also be configured to play user output records 126, such as audio files and/or a playlist. In some embodiments, the electronic device 100 can include multiple user interfaces 110 that can be configured to display image files, video content, audio files and/or a playlist.

The illustrated electronic device 100 also includes a motion detector 130 that is configured to generate motion information indicative of movement of the electronic device 100. The motion detector 130 can include, for example, a motion switch, an accelerometer, and/or an orientation sensor. In some embodiments, the motion detector 130 is configured to detect a specified type of movement, which may be user definable. For example, the motion information can be distinctive for the specified type of movement. In this manner, the electronic device 100 may be responsive only to the specified type of movement.

The illustrated electronic device 100 may include a random number generation module 124 that is configured to generate a random number in response to and corresponding to the motion information generated by the motion detector 130. For example, after receiving the motion information from the motion detector 130, the controller 120 may send a motion related value in the motion information to the random number veneration module 124. In this manner, the random number can be generated using, for example, a relative acceleration value, a frequency of motion value, and/or an intensity of motion value. In some embodiments, the above referenced motion information value(s) can be used as a seed value for the random number generation module 124. The motion information value(s) can also be used in an algorithm that relies on the random characteristics of the motion information value(s).

The illustrated electronic device 100 also includes a controller 120 that is configured to randomly select one user output record 126 for use as a user detectable output. The controller 120 can receive, for example, a random number from the random number generation module 124 and select another user output record 126 for use as the user detectable output. The user output record 126 selected by the controller 120 can include, for example, an electronically-stored image, a sequence of audio data, an electronically-stored audio file, and/or one or more visual properties that correspond to a visual theme. Electronically-stored images, as discussed herein, can be used as background images in a display or images in a slide show sequence, for example. The sequence of audio data can include, for example, a music play list or a sequence of files for audible enunciators, such as ring tones or event reminders. Additionally, visual properties that correspond to a visual theme can include, for example, font, color, and/or style.

The controller 120 can be configured to define the specified type of movement detected by the motion detector 130. For example, the controller 120 can include a program mode that associates specific motion information generated by the motion detector 130 with the specified type of movement. In this manner, the controller 120 can be configured to randomly select a different user output record 126 in response to motion information that corresponds to the specified type of movement. For example, a twisting motion may signal the controller 120 to change an image and a rolling motion may signal the controller 120 to change an audio file and/or playlist. Similarly, a random movement of the electronic device 100 may result in no changes. The user output records 126 can be arranged in an ordered list, such that the controller 120 can be configured to change the order in which user output records 126 are selected for the user interface 110.

The illustrated electronic device 100 also may include a disable switch 140 that is configured to generate a disable signal in response to the motion information. The controller 120 can be configured to maintain the currently selected user output record 126 when the disable signal is at one state and to randomly select a user output record 126 in response to motion information when the disable signal is at another state. The disable switch 140 may include a software switch and/or a hardware switch. The disable switch 140 can be a physical mechanism for disabling the response of the controller 120 to the motion information. The disable switch 140 can also be a multi-function switch that is configured to selectively disable the response of the controller 120. In this manner, for example, the multi-function switch can generate multiple states that are used to configure the controller 120 to be selectively responsive to the motion information as to different user interfaces 110. For example, the disable switch 140 can be utilized to cause the controller 120 to respond to motion information as to the display device 120, but not as to the audio output device 114.

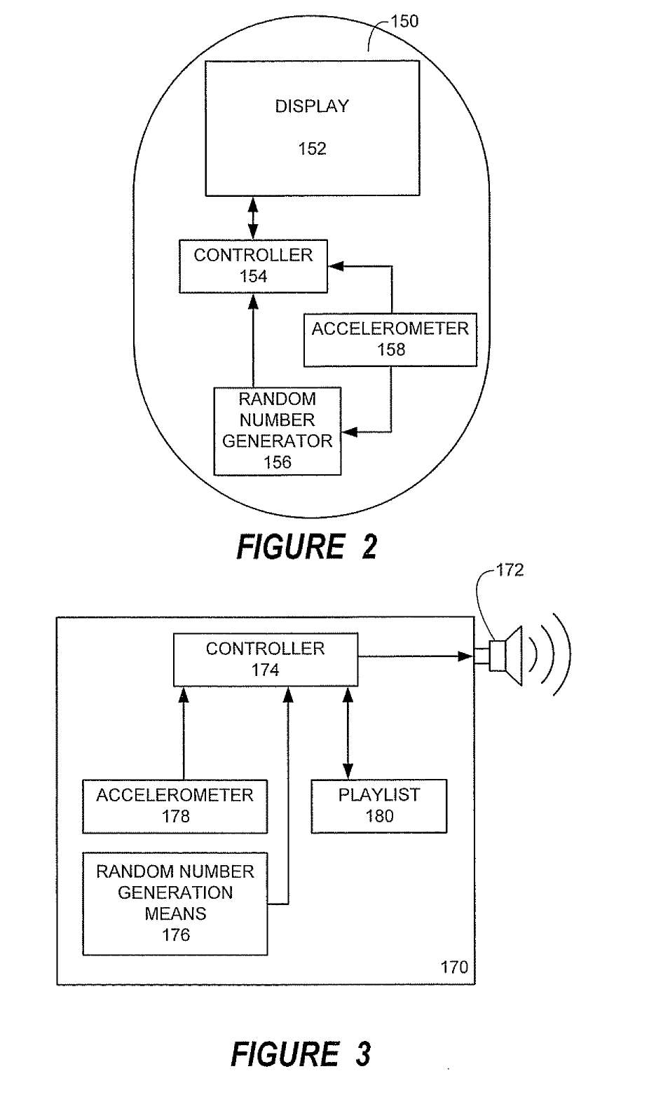

An electronic device having a display according to some embodiments of the present invention will now be described with reference to the block diagram of FIG. 2. The electronic device 150 includes a display 152, a controller 154, a random number generator 156, and an accelerometer 158. The display 152 is configured to communicate text, images, and video to a user. In addition to providing a sensory input to a user, the display 152 can also be used by the user to provide input to the electronic device 150, using, for example, touch screen technology. The electronic device 15 also includes an accelerometer 158 that is configured to generate acceleration information corresponding to movement of the electronic device 150. In this manner, when the electronic device 150 is shaken, for example, acceleration information in the form of, for example, a motion signal can be used by the random number generator 156 to generate a random number, which can be sent to the controller 154.

The controller 154 is configured to select one user output record of multiple user output records to be displayed. Upon receipt of the motion signal, the controller 154 is configured to select another user output record of the multiple user output records in response to the motion signal. The user output records can include electronically-stored images for use as a display background or slide show presentation, digital video, one or more visual properties that correspond to, for example, a visual theme, and sequences thereof

In a case where a response to the motion signal by the controller 154 is not desirable, a disable switch 156 is provided. The disable switch 156 is configured to disable the response of the controller to the motion information. This can be achieved using, for example, a disable signal that is configured to include multiple states. In this manner, a user can enable the motion responsive operation and shake the electronic device 150 to effect one or more display chances. Further, when a desirable image or sequence thereof is selected by the controller 154 responsive to the motion of the electronic device 150, a user may disable the motion response operation of the controller. The visual file record may remain unchanged regardless of motion of the electronic device 150 while the disable is selected.

An electronic device having an audio output according to some embodiments of the present invention will now be described with reference to the block diagram of FIG. 3. The electronic device 170 includes an audio output device 172. The audio output device 172 of some embodiments can be a speaker and/or other audio driver mounted in the electronic device 170. The audio output device 172 can also be a speakerjack that is configured to transmit an electronic signal corresponding to an audio output. In this manner, the speakerjack can be connected to a speaker or similar driver through, for example, a wired connection. The audio output device 172 can also be a speaker that is remotely located and configured to receive an electronic signal corresponding to an audio output via wireless transmission techniques.

The illustrated electronic device 170 also includes a controller 174 configured to select an audio file to be played through the audio output device 172. The electronic device 170 further includes an accelerometer 178 that is configured to generate acceleration information corresponding to movement of the electronic device 170. The acceleration information can be configured as a motion signal. The motion signal can be used by a random number generation means 176 to generate a random number or value. The random number can then be delivered to the controller 174. The illustrated electronic device 170 also includes a playlist 180 that includes a sequence corresponding to audio files, or file records, to be transmitted by the electronic device 170 through the audio output device 172. When the controller 174 receives a random number from the random number generator 176, an alternative sequence of audio files that is based on the random number can be generated and stored as a playlist 180. In this manner, when the electronic device 170 is, for example, shaken, the sequence of audio files in the playlist 180 may be modified.

A disable switch can be included in the electronic device 170 that is configured to disable the response of the controller to the motion signal. The disable switch 176 may limit the modification of the sequence of the playlist 180 when the electronic device 170 is shaken or otherwise moved. The disable switch 176 can act to limit generation by the accelerometer 178 of the acceleration information or motion signal. By limiting generation of the motion signal, the corresponding response from the controller 174 may be limited.

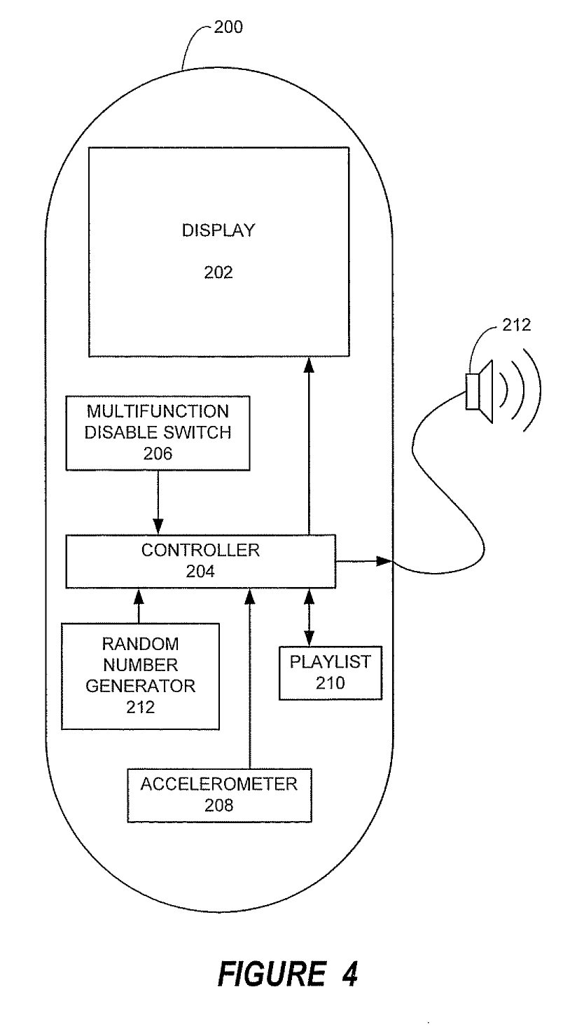

An electronic device having an audio output and a display according to some embodiments of the present invention will now be described with reference to the block diagram of FIG. 4. The electronic device 200 includes a display 202 configured to communicate visual output to a user and an audio output device 212 configured to communicate an audio signal to a user. The electronic device 200 further includes a controller 204 configured to select a file record for each of the display 202 and the audio output device 212. For example, the controller 204 can select an audio file or sequence thereof for the audio output device 212. Similarly, the controller 204 can select an image or video file for the display 202 in coordination with or independent of the audio output device 212.

The electronic device 200 also includes an accelerometer 208 configured to generate acceleration information corresponding to the movement of the electronic device 200. In this manner, a motion signal, for example, is generated responsive to motion of the electronic device 200. The motion signal is used by the random number generator 212 to generate a random number or value. The random number can be generated from an algorithmic computation based on a variety of motion related values including, but not limited to, frequency of motion, intensity of motion, and/or duration of motion, among others. Additionally, the algorithm can further use values unrelated to motion of the electronic device 200, including, for example, time of day, length of time between recent device events, and resource allotment values, such as memory usage, among others.

The random number is communicated to, for example, the controller 204, which can select a new file record for either or both of the display 202 and the audio output device 212. The electronic device 200 can also include a playlist 210, which can be one or more sequences of audio and/or video files. The electronic device 200 further includes a multifunction disable switch 206. The multifunction disable switch 206 can allow the user to determine how the controller 204 will respond to the receipt of a motion signal from the accelerometer 208. For example, in one setting (state), the multifunction disable switch 206 can be configured such that the receipt of a motion signal results in no modification of the playlist 210 with respect to the display 202 or the audio output device 212. In another setting (state), the multifunction disable switch 206 will signal the controller 204 to select another file record for display 202, but leave the audio file records for the audio output device unchanged upon receipt of a motion signal. For example, display properties corresponding to a theme such as font, color, and style, can be selected responsive to motion of the electronic device 200 without altering the playlist 210 corresponding to the audio output device 212. In another setting (state), the multifunction disable switch 206 can cause the display 202 to remain unaffected while changing the playlist 210 relative to the audio output device 212. In yet another multifunction disable switch 206 configuration, the motion signal can be used to select different file records or sequences for both the display 202 and the audio device 212. Additionally, in the case of video signals that include both visual and audio content such that the display 202 and the audio output device 212 are coordinated, the motion signal can be used to select another video file or sequence thereof. The multifunction disable switch 206 can be implemented as a hardware switch and/or a software switch.

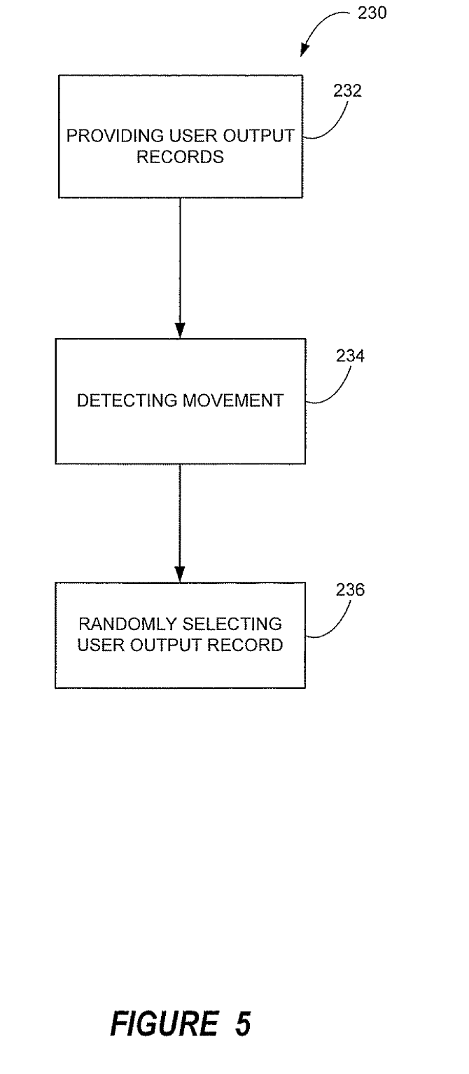

Reference is now made to FIG. 5, which is a block diagram illustrating a method of selecting a user detectable output of a portable electronic device according to some embodiments. A method 230 includes providing user output records (block 232.) The user output records can be stored in a memory located in, for example, a portable electronic device. The user output records can also be stored in a remote memory and transmitted to a portable electronic device. The user output records can be communicated to a user through one or more user interfaces. Exemplary user interfaces include, for example, displays and audio output devices.

The method 230 further includes detecting movement of the device (block 234.) The movement corresponds to motion of the electronic device and can be sensed using an accelerometer or other motion detecting device. In some embodiments, detecting movement includes detecting a specified type of movement, which can be defined by the user. The method further includes randomly selecting a user output record (block 236.) The user output record is selected responsive to the detected movement of the electronic device. Randomly selecting the user output record can be performed using, for example, a random value generated by a random value generation module. In this manner, the output from the electronic device can be modified in a random fashion by causing movement of the electronic device. After the selecting, the method can include displaying, for example, visual properties that correspond to a visual theme, a background image, and/or a video file. After selecting, the method can also include playing an audio file and/or music playlist.

The method 230 can also include selectively disabling the selecting function. For example, when a user does not want device movement to result in the random selection of a user output record, the selecting function can be disabled using, for example, a disable switch. The disable switch can be a hardware switch, a software switch, or some combination thereof. The output to the user can be, for example, a sequence of electronically-stored files such as audio files and/or image files, among others. Additionally, the method 230 can include storing the files within the electronic device and/or on a remote device.

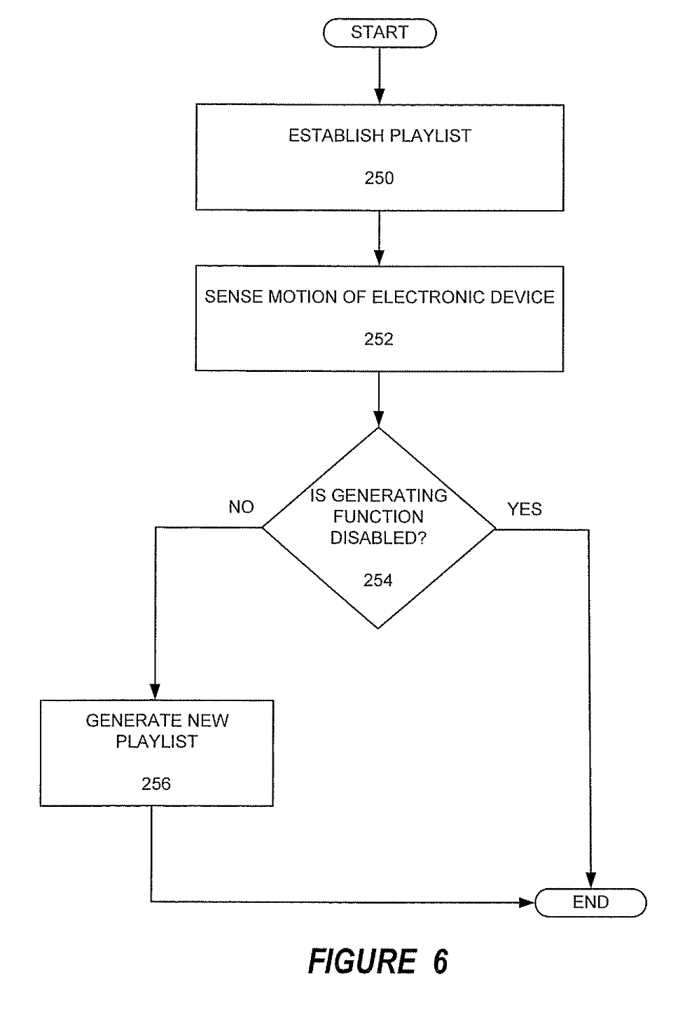

Reference is now made to FIG. 6, which is a flow diagram illustrating disable operations in accordance with some embodiments of the present invention. At block 250, a playlist or other sequence of user interface outputs is established. When the electronic device is moved, such as through a shaking movement, the motion of the electronic device is sensed in block 252. If the generating operation is disabled in block 254, then the playlist established in block 250 remains unmodified. Alternatively, if the generating operation is not disabled in block 254, then a new playlist is generated in block 256. The generating operation can be disabled using a variety of different approaches. In this regard, in some embodiments, a controller can be configured to ignore a motion signal that has been generated. A motion detector can also be disabled such that a motion signal is not generated in response to movement of the electronic device.

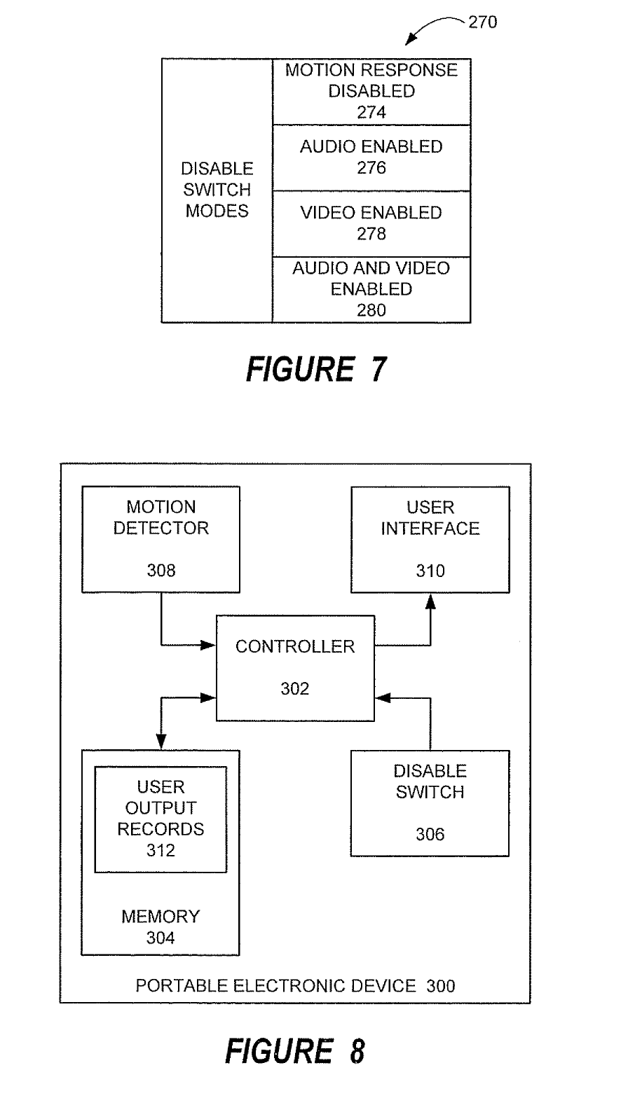

Reference is now made to FIG. 7, which is a table illustrating exemplary functions of a multifunction disable switch according to various embodiments of the present invention. The table 270 includes a column describing the modes of a multifunction disable switch. One mode of the multifunction disable switch is motion response disabled mode 274. In the motion response disabled mode 274, the controller will not respond to a motion signal from a motion detecting device. In this manner, the image, audio file, or sequence of images and/or audio files will not change responsive to movement of the electronic device. Another mode is the audio enabled mode 276. The audio enabled mode 276 permits the user to move or shake the electronic device to cause a new audio file and/or sequence of audio files to be selected. Similarly, a video enabled mode 278 enables the user to select a new image file, video file, or sequence thereof by shaking or moving the electronic device. Yet another mode can be an audio and video enabled mode 280, where the user can change both the audio and video files, sequences, and/or properties by shaking the electronic device. The various modes of the multifunction disable switch can be selected using, for example, a disable signal that includes multiple states, each corresponding to one of the modes.

A portable electronic device according to other embodiments of the present invention will now be described with reference to the block diagram of FIG. 8. The portable electronic device 300 includes user output records 312 that can be communicated to a user through a user interface 310. The user interface 310 can be configured to provide the user output records 312 as video or audio outputs. Some embodiments include multiple user interfaces 310 to provide both video and audio outputs to a user. In this regard, the user output records 312 can include image files, audio files, playlists, or a combination thereof. The portable electronic device 300 further includes a motion detector 308 that is configured to generate motion information indicative of movement of the electronic device. In this manner, when the portable electronic device 300 is moved, a motion signal can be generated by the motion detector 308. The motion detector 308 can include, for example, an accelerometer, a motion switch, and/or an orientation sensor. The portable electronic device 300 further includes a memory 304 that is configured to electronically store user output records 312 such as audio files or segments. The portable electronic device 300 further includes a disable switch 306 that is configured to generate a disable signal. The disable signal can include, for example, two states.

The portable electronic device 300 includes a controller 302 that is configured to maintain a selection of previously selected user output records 312 in response to one of the disable signal states. The controller 302 is configured to randomly select one of the user output records 312 in response to a motion signal when the disable signal is in another state. In this manner, when the motion detector 308 generates a motion signal and the disable switch 306 generates an enable signal, the controller 302 will determine a new random order or sequence of user output records 312. When the disable switch 306 generates a disable signal, the original sequence is maintained regardless of motion of the portable electronic device 300. The disable switch 306 can be configured as a multiple function switch to selectively disable motion response in a portable electronic device 300 that includes more than one user interface 308.

As will be appreciated by one of skill in the art, the present invention may be embodied as a method, circuit or communication system. Accordingly, the present invention may take the form of an entirely hardware embodiment, an entirely software embodiment or an embodiment combining software and hardware aspects, all generally referred to herein as a “circuit.”

Computer program code for carrying out operations of the present invention may be written in an object oriented programming language such as Java@, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

The present invention is described above with reference to flowchart illustrations and/or block and/or flow diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block and/or flow diagram block or blocks.

These computer program instructions may also be stored in a computer-readable memory that can direct a computer or other programmable processor to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks.

In the drawings and specification, there have been disclosed exemplary embodiments of the invention. Although specific terms are employed, they are used in a generic and descriptive sense only and not for purposes of limitations the scope of the invention being defined by the following claims.

That which is claimed is:

1. A portable electronic device comprising:
a plurality of user output records;
a user interface configured to generate a user detectable output corresponding to a selected one of the plurality of user output records;
a motion detector configured to generate motion information that is indicative of movement of the electronic device; and
a controller configured to randomly select one of the plurality of user output records to be generated by the user interface as the user detectable output responsive to the motion information.

2. The device of claim 1, wherein the motion detector is configured to detect a specified type of movement and the controller is configured to select one of the plurality of user output records when the motion information indicates the specified type of movement.

3. The device of claim 2, wherein the specified type of movement is user definable and wherein the controller is configured to define the specified type of movement based on the motion information when a program mode of the controller is selected.

4. The device of claim 2, wherein the specified type of movement comprises a plurality of specified types of movement and wherein the controller is configured to select different one of the user output records responsive to respective ones of the plurality of specified types of movement.

5. The device of claim 1, further comprising a random number generation module that is configured to generate a random number responsive to the motion information and wherein the controller is configured to randomly select one of the plurality of user output records based on the random number.

6. The device of claim 1, wherein the plurality of user output records is an ordered list and wherein the controller is configured to sequentially select user output records from the ordered list for output by the user interface and to change the order in which the user output records are selected responsive to the motion information.

7. The device of claim 1, wherein the user interface comprises a display device and wherein the user output records comprise a plurality of visual properties that correspond to a visual theme, a background image and/or a video file.

8. The device of claim 7, wherein the plurality of visual properties comprises font, color and/or style.

9. The device of claim 1, wherein the user interface comprises an audio output device and wherein the user output records comprise an audio file and/or a music playlist.

10. The device of claim 1, further comprising a disable switch configured to generate a disable signal, wherein the controller is configured to maintain a selection of a previously selected one of the plurality of user output records responsive to a first state of the disable signal and to randomly select one of the plurality of user output records to be generated by the user interface as the user detectable output responsive to the motion information responsive to a second state of the disable signal.

11. The device of claim 10, wherein the controller is configured to separately select the plurality of user output records for a plurality of different user interfaces and wherein the disable switch comprises a multi-function switch that is configured to select disable of ones of the user interfaces and wherein the first state of the disable signal comprises a plurality of states, ones of which correspond to different ones of the different user interfaces and wherein the controller is configured to maintain a corresponding previously selected one of the user output records for the user interface selected by the multi-function switch.

12. The device of claim 1, further comprising a memory, wherein the plurality of user output records are stored in the memory.

13. The device of claim 1, further comprising means for generating a random number responsive to the motion information.

14. A method of selecting a user detectable output of a portable electronic device, the method comprising:
providing a plurality of user output records;
detecting movement of the electronic device; and
randomly selecting one of the plurality of user output records to be generated by a user interface as the user detectable output responsive to the motion information.

15. The method of claim 14, further comprising detecting a specified type of movement and wherein selecting comprises selecting one of the plurality of user records responsive to the specified type of movement.

16. The method of claim 15, wherein the specified type of movement comprises a user defined movement.

17. The method of claim 14, wherein selecting is preceded by generating, responsive to the motion information, a random number and wherein selecting comprises selecting based on the random number.

18. The method of claim 14, wherein the plurality of user output records comprises an ordered list and wherein selecting comprises sequentially selecting user output records from the ordered list for output and changing the order in which the user output records are selected responsive to the motion information.

19. The method of claim 14, wherein selecting is followed by displaying the selected user output record, wherein the selected user output record comprises a plurality of visual properties that correspond to a visual theme, a background image and/or a video file.

20. The method of claim 14, wherein selecting is followed by playing the selected user output record, wherein the selected user output record comprises an audio file and/or a music playlist.

21. The method of claim 14, wherein selecting is preceded by detecting a disable signal and wherein selecting comprises maintaining a selection of a previously selected one of the plurality of user output records responsive to a first state of the disable signal and randomly selecting one of the plurality of user output records to be generated by the user interface as the user detectable output responsive to the motion information responsive to a second state of the disable signal.

22. A computer system configured to carry out the method of claim 14.

23. A computer program product for selecting a user detectable output of a portable electronic device, the computer program product comprising computer program code embodied in a computer readable medium, the computer program code comprising program code configured to carry out the method of claim 14.

24. A portable electronic device comprising:
a memory;
a plurality of user output records stored in the memory;
a user interface configured to generate a user detectable output corresponding to a selected one of the plurality of user output records;
a motion detector configured to generate motion information that is indicative of movement of the electronic device;
a disable switch configured to generate a disable signal; and
a controller configured to maintain a selection of previously selected one of the plurality of user output records responsive to a first state of the disable signal and to randomly select one of the plurality of user output records to be generated by the user interface as the user detectable output responsive to the motion information and a second state of the disable signal.

25. The device of claim 24, wherein at least one of the plurality of user output records is an image file.

26. The device of claim 24, wherein at least one of the plurality of user output records is a music playlist and wherein the controller is configured to sequentially select songs from the music playlist to be played by the user interface and to change the order in which the songs are selected responsive to the motion information and the second state of the disable signal.
